(19) United States
(12) Patent Application Publication
(10) Pub. No.: US 2026/0329520 A1
(43) Pub. Date: Oct. 22, 2026

(54) VIDEO SIGNAL SWITCHING DEVICE AND VIDEO SIGNAL SWITCHING METHOD

(71) Applicant: Sharp Kabushiki Kaisha, Sakai City (JP)

(72) Inventor: Hisato KUMAI, Sakai City (JP)

(21) Appl. No.: 19/699,423

(22) Filed: Jun. 5, 2026

Related U.S. Application Data
(63) Continuation of application No. PCT/JP2023/044224, filed on Dec. 11, 2023.

(51) Int. Cl. G06F 3/147; G06T 11/00

(52) U.S. Cl. CPC G06F 3/147; G06T 11/00

(57) ABSTRACT

A video signal switching device includes a signal number acquisitor configured to acquire the number of video signals to be input to a plurality of video terminals of an electronic device and a switcher configured to perform switching operations, on the basis of the number of video signals and a threshold. The switcher is configured to switch, based on a first mode operator as operated and included in a plurality of first mode operators configured to receive video signal switching operation, video signals from the plurality of video terminals respectively allocated with the plurality of first mode operators, in case that the number of video signals acquired exceeds the threshold. The switcher is configured to switch the video signals every time operation of a second mode operator configured to receive video signal switching operation, in case that the number of video signals acquired does not exceed the threshold.

### BACKGROUND OF THE INVENTION

### Field of the Invention

The present invention relates to a video signal switching device and a video signal switching method.

### Description of Related Art

A video signal switching device that can allow a user to arbitrarily switch a video terminal for receiving an input of a video signal is provided in a display device including a plurality of video terminals. Such video signal switching devices are classified using the following two methods.
(1) A method of providing keys or buttons corresponding to video terminals and allowing a user to directly operate the key or button which is a desired option in a remote controller or a main body to select a video terminal
(2) A method of sequentially switching a video terminal to video terminals whenever one key or button is pressed

Patent Document 1 proposes a video signal switching device that can more rapidly switch to a desired video terminal by determining whether a corresponding video signal is currently being input to each of a plurality of video terminals and displaying only information of a video terminal to which a video signal is currently being input as selection candidate information on the basis of a result of determination thereof.

### PATENT DOCUMENTS

[Patent Document 1] Japanese Unexamined Patent Application, First Publication No. 2011-40958

### SUMMARY OF THE INVENTION

In the method of providing keys or buttons corresponding to the video terminals, the keys or buttons need to be provided to correspond to the number of video terminals, and thus it is necessary to secure a broad space for providing the keys or buttons. In the method of sequentially switching a video signal whenever one key or button is pressed, when the number of video signals increases, the key or button needs to be pressed a plurality of times to switch to a desired video terminal. Accordingly, a long switching time for switching to the desired video terminal is required.

In consideration of the aforementioned circumstances, an objective of the present invention is to provide a video signal switching device and a video signal switching method that can easily select a desired video terminal out of a plurality of video terminals.

According to an aspect of the present invention, there is provided a video signal switching device including: a signal number acquisitor configured to acquire the number of video signals which are to be input to video terminals of an electronic device including a plurality of video terminals to which video signals which are externally supplied are able to be input; and a switcher configured to switch a video signal to a video signal from the video terminal corresponding to an operator on which an operation input has been performed out of operators allocated to the plurality of video terminals to which the video signals are to be input on the basis of the acquired number of video signals and a threshold value when the acquired number of video signals is greater than the threshold value and to switch the video signal whenever an operation input is performed on one operator which is allocated as an operator which is able to receive an operation of switching the video signals when the acquired number of video signals is equal to or less than the threshold value.

According to another aspect of the present invention, there is provided a video signal switching method including: a step of acquiring the number of video signals which are to be input to video terminals of an electronic device including a plurality of video terminals to which video signals which are externally supplied are able to be input; and a step of switching the video signal to a video signal from the video terminal corresponding to an operator on which an operation input has been performed out of operators allocated to the plurality of video terminals to which the video signals are to be input on the basis of the acquired number of video signals and a threshold value when the acquired number of video signals is greater than the threshold value and switching the video signal whenever an operation input is performed on one operator which is allocated as an operator which is able to receive an operation of switching the video signal when the acquired number of video signals is equal to or less than the threshold value.

According to the present invention, it is possible to perform the video signal switching operation through an operation of one operator when the number of video signals is equal to or less than the threshold value, and it is possible to perform the video signal switching operation using an operator corresponding to an input terminal out of a plurality of operators when the number of video signals is greater than the threshold value. Accordingly, it is possible to easily select a desired video terminal out of a plurality of video terminals.

### BRIEF DESCRIPTION OF THE DRAWINGS

FIG. 1 is a diagram schematically illustrating a configuration of a front surface of a display device to which a video signal switching device according to a first embodiment of the present invention can be applied.

FIG. 2 is a diagram schematically illustrating a configuration of a rear surface of the display device to which the video signal switching device according to the first embodiment of the present invention can be applied.

FIG. 3 is a block diagram schematically illustrating a configuration of the display device to which the video signal switching device according to the first embodiment of the present invention can be applied.

FIG. 4 is a diagram illustrating a process when a video input is switched in the display device according to the first embodiment of the present invention.

FIG. 5 is a diagram illustrating a process when a video input is switched in the display device according to the first embodiment of the present invention.

FIG. 6 is a diagram illustrating a process when a video input is switched in the display device according to the first embodiment of the present invention.

FIG. 7 is a diagram illustrating a process when a video input is switched in the display device according to the first embodiment of the present invention.

FIG. 8 is a diagram illustrating a process when a video input is switched in the display device according to the first embodiment of the present invention.

FIG. 9 is a diagram illustrating a process when a video input is switched in the display device according to the first embodiment of the present invention.

FIG. 10 is a flowchart illustrating a flow of a video input process according to the first embodiment of the present invention.

FIG. 11 is a block diagram schematically illustrating a configuration of a display device to which a video signal switching device according to a second embodiment of the present invention can be applied.

FIG. 12 is a flowchart illustrating a flow of a video input process according to the second embodiment of the present invention.

FIG. 13 is a flowchart illustrating a flow of the video input process according to the second embodiment of the present invention.

FIG. 14 is a diagram illustrating a modified example of the present invention.

FIG. 15 is a block diagram illustrating a video signal switching device according to another aspect of the present invention.

### DETAILED DESCRIPTION OF THE INVENTION

Hereinafter, embodiments of the present invention will be described with reference to the accompanying drawings.

### First Embodiment

FIG. 1 is a diagram schematically illustrating a configuration of a front surface of a display device 1 to which a video signal switching device according to a first embodiment of the present invention can be applied.

As illustrated in FIG. 1, a video display device 10 is provided on the front surface of the display device 1 with a bezel 11. For example, a liquid crystal display is used as the video display device 10. The video display device 10 may be a display device other than a liquid crystal display, for example, an organic electroluminescence display device, an inorganic electroluminescence display device, a plasma address liquid crystal (PALC) device, a plasma display panel (PDP), or a field emission display (FED). The video display device 10 may be a projector.

A plurality of operators 20, 21, and 22-1 to 22-4 are provided below a periphery of the video display device 10. The functions of the operators 20, 21, and 22-1 to 22-4 are represented by on-screen display (OSD) images E20, E21, and E22-1 to E22-4 below the video display device 10 to correspond to the positions of the operators 20, 21, and 22-1 to 22-4. Mechanical switches or electrostatic switches can be used as the operators 20, 21, and 22-1 to 22-4.

For example, the OSD image E20 is disposed at a position in the video display device 10 near above the operator 20 for the operator 20, and the operator 20 and the OSD image E20 are correlated. For example, the OSD image E22-1 is disposed at a position in the video display device 10 near above the operator 22-1 for the operator 22-1, and the operator 22-1 and the OSD image E22-1 are correlated. For example, the OSD image E22-3 is disposed at a position in the video display device 10 near above the operator 22-3 for the operator 22-3, and the operator 22-3 and the OSD image E22-3 are correlated.

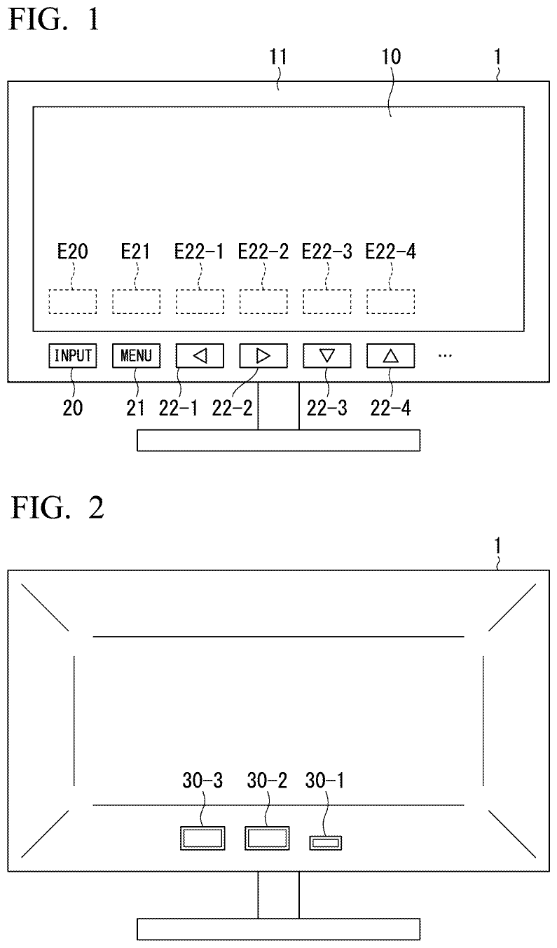

FIG. 2 is a diagram schematically illustrating a configuration of a rear surface of the display device 1 to which the video signal switching device according to the first embodiment of the present invention can be applied.

As illustrated in FIG. 2, a plurality of video terminals 30-1, 30-2, and 30-3 are provided on the rear surface of the display device 1. The video terminals 30-1, 30-2, and 30-3 can receive an input of a video signal which is externally supplied. The video terminal 30-1 is, for example, a universal serial bus type C (USB-C) terminal, the video terminal 30-2 is, for example, a display port (DP) terminal, and the video terminal 30-3 is, for example, a high-definition multimedia interface (HDMI) terminal (where HDMI is a registered trademark). Here, three video terminals 30-1 to 30-3 are illustrated, but the number of video terminals is not limited thereto. In addition, other type terminals such as digital visual interface (DVI) terminals or video graphics array (VGA) terminals may be provided as the video terminals 30-1, 30-2, and 30-3.

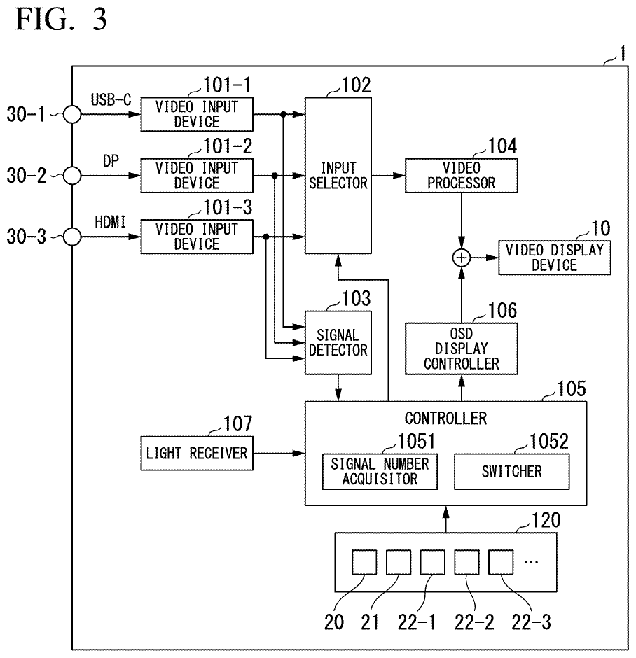

FIG. 3 is a block diagram schematically illustrating a configuration of the display device 1 to which the video signal switching device according to the first embodiment of the present invention can be applied. The display device 1 illustrated in FIG. 3 includes a video display device 10, video input devices 101a to 101c, an input selector 102, a signal detector 103, a video processor 104, a controller 105, an OSD display controller 106, a light receiver 107, and a switcher 120. The operators 20, 21, and 22-1 to 22-4 are arranged in the switcher 120. The video terminals 30-1 to 30-3 are provided in the display device 1.

An external electronic device (for example, a personal computer (PC)) is connected to the video terminals 30-1 to 30-3. Video signals from the video terminals 30-1 to 30-3 are supplied to the input selector 102 via the video input devices 101-1 to 101-3 and are supplied to the signal detector 103.

The input selector 102 selects one video signal out of video signals input to the video terminals 30-1 to 30-3 on the basis of a video selection signal output from the controller 105 and supplies the selected video signal to the video processor 104.

The signal detector 103 detects whether there is a video input from the video terminals 30-1 to 30-3 and outputs the detected video to the controller 105.

The video processor 104 performs predetermined signal processing on the video signal output from the input selector 102 and displays the processed video signal on the video display device 10.

The controller 105 is constituted by a central processing unit (CPU) or the like and performs various processes on the basis of a program. In the present embodiment, the controller 105 switches the functions of the operators 20, 21, and 22-1 to 22-4 at the time of selection of a video input according to the number of video terminals receiving a video input to the video terminals 30-1 to 30-3 and displays the functions on a screen as OSD images E20, E21, and E22-1 to E22-4.

More specifically, the controller 105 realizes functions of a signal number acquisitor 1051 that acquires the number of video signals input to the video terminals 30-1 to 30-3 to which video signals externally supplied can be input and a switcher 1052 that switches the functions of the operators 20, 21, and 22-1 to 22-4 according to the acquired number of video signals.

That is, the controller 105 acquires the number of video signals externally input to the video terminals 30-1 to 30-3 from a detection signal of the signal detector 103. When the acquired number of video signals is equal to or less than a threshold value K, the controller 105 allocates the functions of the operators 20, 21, and 22-1 to 22-4 such that a video input is sequentially switched whenever an operation is input to one operator (for example, the operator 20) allocated as an operator capable of receiving an operation of switching a video signal on the basis of an operation input to the one operator (hereinafter referred to as a toggle operation mode). In correspondence therewith, the controller 105 displays the functions of the operators 20, 21, and 22-1 to 22-4 as OSD images E20, E21, and E22-1 to E22-4.

When the acquired number of video signals is equal to or greater than a threshold value (K+1), the controller 105 allocates the operators 20, 21, and 22-1 to 22-4 and the video terminals 30-1 to 30-3 in correlation and sets the functions such that the corresponding video terminals (for example, the video terminals 30-1 to 30-3) are switched when the allocated operators (for example, the operators 22-1 to 22-3) are operated (hereinafter referred to as a total display selected operation mode). In correspondence therewith, the controller 105 displays the functions of the operators 20, 21, and 22-1 to 22-4 in the OSD images E20, E21, and E22-1 to E22-4.

Here, when the acquired number of video signals is equal to or less than the threshold value K, one operator (for example, the operator 20) is allocated as the operator that can receive an operation of switching a video signal. This one operator is selected out of operators (for example, the operator 20 and the operator 22-4) different from the operators (for example, the operators 22-1 to 22-3) allocated as the operator that can receive the video signal switching operation when the acquired number of video signals is equal to or greater than the threshold value (K+1). In the present embodiment, the one operator is allocated to the operator 20, but may be allocated to the operator 22-4.

When the number of video signals detected is equal to or less than the threshold value and the acquired number of video signals is 1, the controller 105 does not perform switching even if an operation input is performed. When switching is not performed, it may mean that the operation input is received but switching is not performed or may mean that switching is not performed by not receiving an operation input from the operators 20, 21, and 22-1 to 22-4.

The OSD display controller 106 generates an OSD display signal on the basis of a control signal from the controller 105 and displays the generated OSD display signal on the video display device 10 to overlap a video signal from the video processor 104. In the present embodiment, the OSD display controller 106 generates OSD images E20, E21, and E22-1 to E22-4 corresponding to the operators 20, 21, and 22-1 to 22-4 on the basis of a control signal from the controller 105.

The light receiver 107 receives an infrared signal from a remote controller (not illustrated) and transmits the received infrared signal to the controller 105.

As described above, the operators 20, 21, and 22-1 to 22-4 are arranged in the switcher 120.

A process when a video input is switched in the display device 1 according to the first embodiment of the present invention will be described below. In the following example, it is assumed that the threshold value K is 2 (K=2). It is assumed that the video terminal 30-1 (the USB-C terminal) corresponds to the operator 22-1, the video terminal 30-2 (the DP terminal) corresponds to the operator 22-2, and the video terminal 30-2 (the HDMI terminal) corresponds to the operator 22-3.

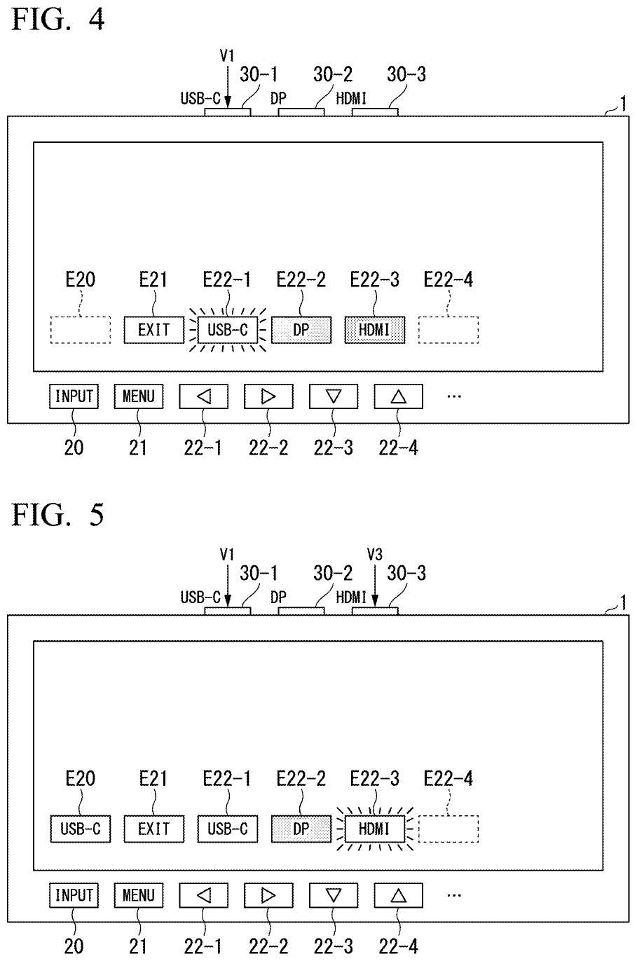

FIGS. 4 to 9 are diagrams illustrating a process when a video input is switched in the display device 1 according to the first embodiment of the present invention. FIG. 4 illustrates an example in which the number of video inputs is 1. In this example, as illustrated in FIG. 4, a video signal V1 is input to the video terminal 30-1 (the USB-C terminal), and no video signal is input to the other video terminals 30-2 (the DP terminal) and 30-3 (the HDMI terminal).

When the number of video inputs is 1, OSD images E20, E21, and E22-1 to E22-3 are displayed as illustrated in FIG. 4. Since the operator 21 functions as an exit operator, “EXIT” is displayed as the OSD image E21. Since the operators 22-1 to 22-3 correspond to the video terminals 30-1 to 30-3, “USB-C (indicating a name of the video terminal 30-1),” “DP (indicating a name of the video terminal 30-2),” and “HDMI (indicating a name of the video terminal 30-3)” are displayed as the OSD images E22-1 to E22-3. Here, since no video input is input to the video terminals 30-2 and 30-3, the OSD images E22-2 and E22-3 are grayed out. Since a video signal V1 is input to only the video terminal 30-1, only the video terminal 30-1 can be selected. Accordingly, the background color of characters in the OSD image E22-1 is displayed as a predetermined color (for example, yellow) different from the background color of the other OSD images, which represents that the video terminal 30-1 is selected. When the number of video inputs is 1, the video input is not switched even if any operator is operated.

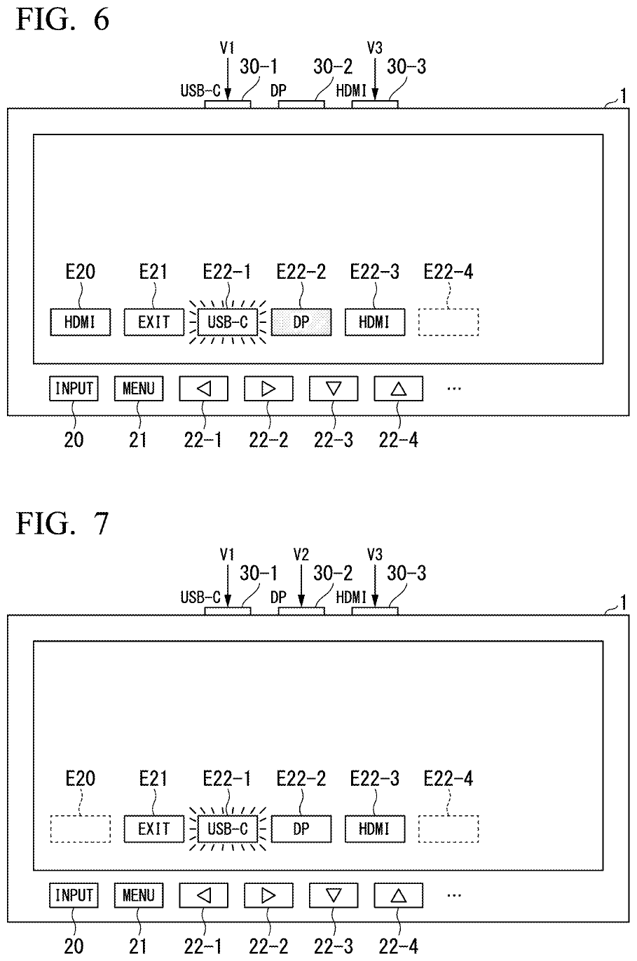

FIGS. 5 and 6 illustrate an example in which the number of video inputs is 2. In this example, as illustrated in FIGS. 5 and 6, a video signal V1 is input to the video terminal 30-1 (the USB-C terminal), and a video signal V3 is input to the video terminal 30-3 (the HDMI terminal). No video signal is input to the video terminal 30-2 (the DP terminal). In this example, since the threshold value K is set to 2, the number of video signals is equal to or less than the threshold value K when the number of video inputs is 2. When the number of video signals is equal to or less than the threshold value K, the video input is sequentially switched on the basis of an operation input to one operator. In this example, the operator 20 functions as an input switching switch, and the video input is sequentially switched whenever the operator 20 is operated. That is, when the number of video signals is equal to or less than the threshold value K, the toggle operation mode operates.

As illustrated in FIG. 5, “USB-C” is displayed as the OSD image E20. This represents that a video input which is selected next time is the video terminal 30-1 (the USB-C terminal). Since the operator 21 functions as the exit switch, “EXIT” is displayed as the OSD image E21.

Since the operators 22-1 to 22-3 correspond to the video terminals 30-1 to 30-3, “USB-C (indicating a name of the video terminal 30-1),” “DP (indicating a name of the video terminal 30-2),” and “HDMI (indicating a name of the video terminal 30-3)” are displayed as the OSD images E22-1 to E22-3. Here, since no video input is input to the video terminal 30-2, the OSD image E22-2 is grayed out. When it is assumed that the video terminal 30-3 (the HDMI terminal) is currently selected, the background color of characters in the OSD image E22-3 is displayed as a predetermined color (for example, yellow) different from the background color of the other OSD images.

Here, when the operator 20 is operated one time, the video terminal 30-1 (the USB-C terminal) is selected, and the video input thereto is switched to the OSD image illustrated in FIG. 6. As illustrated in FIG. 6, since the selected video input is switched to the video terminal 30-1 (the USB-C terminal), the background color of characters in the OSD image E22-1 is displayed as a predetermined color (for example, yellow) different from the background color of the other OSD images. Since a video input which is selected next time is the video terminal 30-3 (the HDMI terminal), “HDMI” is displayed as the OSD image E20.

In this way, when the number of video signals is 2, the OSD image is alternately switched to the OSD image illustrated in FIG. 5 and the OSD image illustrated in FIG. 6 whenever the operator 20 is operated, and the selected video input is alternately switched to the video terminal 30-3 (the HDMI terminal) and the video terminal 30-1 (the USB-C terminal). In the video input which is currently selected, the background color of characters in the OSD image is displayed as a predetermined color (for example, yellow) different from the background color of the other OSD images. What video input is selected when an operation input is performed next time is noticed by displaying the name of the video terminal to which the corresponding video signal is input or a type name of the video signal in the OSD image E20.

FIGS. 7 to 9 illustrate an example in which the number of video signals is 3. In this example, as illustrated in FIGS. 7 to 9, a video signal V1 is input to the video terminal 30-1 (the USB-C terminal), a video signal V2 is input to the video terminal 30-2 (the DP terminal), and a video signal V3 is input to the video terminal 30-3 (the HDMI terminal). In this example, since the threshold value K is set to 2, the number of video signals is equal to or greater than the threshold value (K+1) when the number of video inputs is 3. When the number of video signals is equal to or greater than the threshold value (K+1), the operators 22-1 to 22-3 and the video terminals 30-1 to 30-3 are correlated, and the video input is switched to the corresponding video terminals 30-1 to 30-3 when the operators 22-1 to 22-3 are operated. That is, when the number of video signals is equal to or greater than the threshold value (K+1), the total display selected operation mode operates.

As illustrated in FIG. 7, since the operator 21 functions as the exit switch, “EXIT” is displayed as the OSD image E21. Since the operators 22-1 to 22-3 correspond to the video terminals 30-1 to 30-3, “USB-C (indicating a name of the video terminal 30-1),” “DP (indicating a name of the video terminal 30-2),” and “HDMI (indicating a name of the video terminal 30-3)” are displayed as the OSD images E22-1 to E22-3. When it is assumed that the video terminal 30-1 (the USB-C terminal) is currently selected, the background color of characters in the OSD image E22-1 is displayed as a predetermined color (for example, yellow).

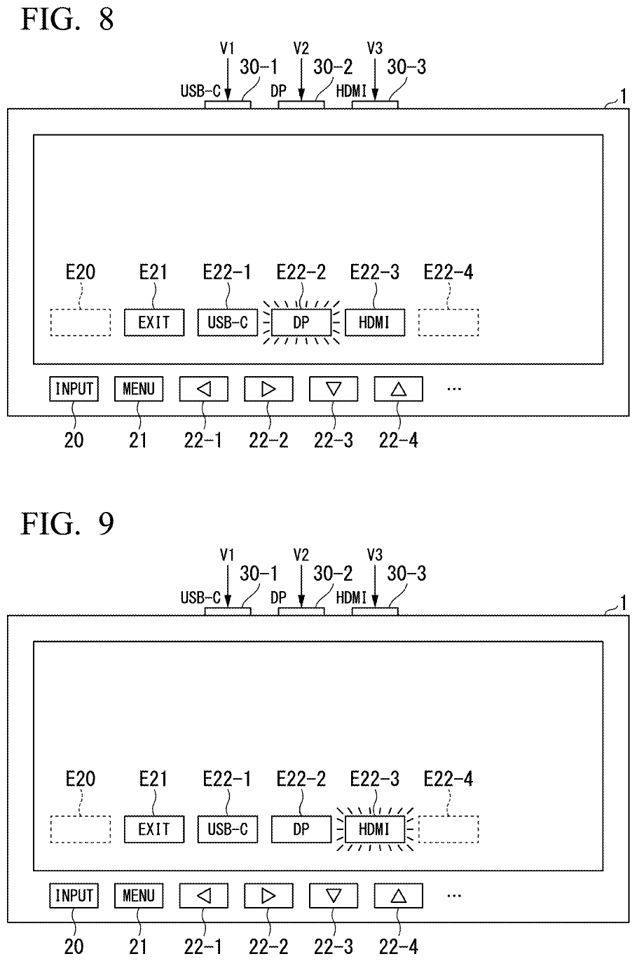

Here, when the operator 22-2 is operated, the video input to the video terminal 30-2 (the DP terminal) corresponding to the operator 22-2 is selected and is switched to the OSD image illustrated in FIG. 8. As illustrated in FIG. 8, since the selected video input is switched to the video terminal 30-2 (the DP terminal), the background color of characters in the OSD image E22-2 is displayed as a predetermined color (for example, yellow).

Then, when the operator 22-3 is operated, the video input to the video terminal 30-3 (the HDMI terminal) corresponding to the operator 22-3 is selected and is switched to the OSD image illustrated in FIG. 9. As illustrated in FIG. 9, since the selected video input is switched to the video terminal 30-3 (the HDMI terminal), the OSD image E22-3 is displayed in a predetermined color (for example, yellow).

In this way, when the number of video inputs is 3 and the operator 22-1 is operated, the video input is switched to the video terminal 30-1 (the USB-C terminal) corresponding to that operator. When the operator 22-2 is operated, the video input is switched to the video terminal 30-2 (the DP terminal) corresponding to that operator. When the operator 22-3 is operated, the video input is switched to the video terminal 30-3 (the HDMI terminal) corresponding to that operator. In the currently selected video input, the background color of characters in the corresponding OSD image is displayed as a predetermined color (for example, yellow).

In this way, in the present embodiment, when the number of video signals is equal to or less than the threshold value K, the toggle operation mode operates, and the video input is sequentially switched whenever the operator 20 is operated. When the number of video signals is equal to or greater than the threshold value (K+1), the total display selected operation mode operates, and the video input is switched to the corresponding video input when one of the operators 22-1 to 22-3 allocated in correlation with the video terminals 30-1 to 30-3 is operated.

The toggle operation mode is noticed by displaying characters indicating what video input is selected when a next operation input is performed in the OSD image E20. On the other hand, in the total display selected operation mode, characters indicating what video input is selected when a next operation input is performed is not displayed in the OSD image E20, and thus the OSD image E20 is in a non-noticed state. Accordingly, a user can ascertain which of the toggle operation mode and the total display selected operation mode is set using the OSD image E20 of the operator 20 functioning as an input switching switch. For example, a user can ascertain that the operation mode is the toggle operation mode when a certain notice is displayed in the OSD image E20 (see FIGS. 5 and 6) and the operation mode is the total display selected operation mode when no notice is displayed (see FIGS. 7 to 9).

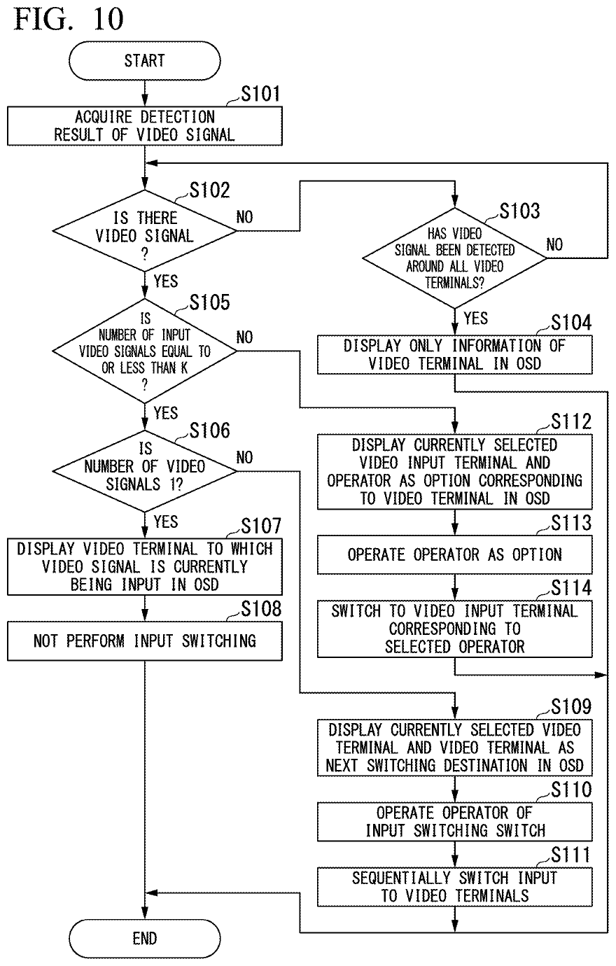

FIG. 10 is a flowchart illustrating a process flow according to the first embodiment of the present invention.
(Step S101) The controller 105 acquires detection results of a video signal from the video terminals 30-1 to 30-3 from the detection signal from the signal detector 103 and causes the process flow to proceed to Step S102.
(Step S102) The controller 105 determines whether a video signal has been detected from the video terminals 30-1 to 30-3. Then, the controller 105 causes the process flow to proceed to Step S103 when no video signal has been detected (Step S102: NO) and causes the process flow to proceed to Step S105 when a video signal has been detected (Step S102: YES).
(Step S103) The controller 105 determines whether it has been determined whether to detect a video signal all over the video terminals 30-1 to 30-3 and returns the process flow to Step S102 when it has not been determined whether to detect a video signal all over the video terminals 30-1 to 30-3 (Step S103: NO). When a video signal has not been detected all over the video terminals 30-1 to 30-3 (Step S103: YES), the controller 105 causes the process flow to proceed to Step S104.
(Step S104) When no video signal from the video terminals 30-1 to 30-3 has been detected all over the video terminals 30-1 to 30-3 (Step S103: YES), the controller 105 grays out only the video terminals 30-1 to 30-3 displayed as the OSD images (the OSD images E22-1 to E22-3) and ends the process flow.
(Step S105) The controller 105 determines whether the number of video terminals from which a video signal has been detected out of the video terminals 30-1 to 30-3 is equal to or less than the threshold value K. The controller 105 causes the process flow to proceed to Step S106 when the number of video terminals from which a video signal has been detected out of the video terminals 30-1 to 30-3 is equal to or greater than the threshold value K is equal to or less than the threshold value K (Step S105: YES) and causes the process flow to proceed to Step S112 when the number of video terminals is not equal to or less than the threshold value K (equal to or greater than K+1) (Step S105: NO).
(Step S106) The controller 105 determines whether the number of video terminals from which a video signal has been detected out of the video terminals 30-1 to 30-3 is 1. The controller 105 causes the process flow to proceed to Step S107 when the number of video terminals from which a video signal has been detected is 1 (Step S106: YES) and causes the process flow to proceed to Step S109 when the number of video terminals from which a video signal has been detected is not 1 (Step S106: NO).
(Step S107) The controller 105 grays out a video terminal from which a video signal has not been detected out of the video terminals 30-1 to 30-3 displayed in the OSD image (the OSD images E22-1 to E22-3), displays the background color of characters in the OSD image corresponding to the video terminal from which a video signal has been detected as a predetermined color (for example, yellow) different from the background color of the other OSD images, and causes the process flow to proceed to Step S108.
(Step S108) The controller 105 does not perform input switching because the number of input video signals is 1.
(Step S109) When it is determined in Step S106 that the number of video terminals from which a video signal has been detected out of the video terminals 30-1 to 30-3 is not 1 (Step S106: NO), the controller 105 grays out a video terminal from which a video signal has not been detected out of the video terminals 30-1 to 30-3 displayed in the OSD image (the OSD images E22-1 to E22-3) and displays the background color of characters in the OSD image corresponding to the currently selected video terminal as a predetermined color (for example, yellow) different from the background color of the other OSD images. The controller 105 displays a next selected video terminal as the OSD image E20.
(Step S110) When a video input is switched, a user operates the operator 20 functioning as an input switching switch.
(Step S111) The controller 105 switches a video input to a next video terminal with the operation on the operator 20.
(Step S112) When it is determined in Step S105 that the number of video terminals from which a video signal has been detected out of the video terminals 30-1 to 30-3 is not equal to or less than the threshold value K (equal to or greater than K+1) (Step S105: NO), the OSD images E22-1 to E22-3 and the operators 22-1 to 22-3 serving as options of the video terminals 30-1 to 30-3 are displayed in correlation. The controller 105 displays the background color of characters in the currently selected OSD image corresponding to the video terminal as a predetermined color (for example, yellow) different from the background color of the other OSD images.
(Step S113) When the video input is switched, a user operates the operator corresponding to a desired video terminal out of the operators 22-1 to 22-3.
(Step S114) The controller 105 performs switching to a video input corresponding to the operated operator out of the operators 22-1 to 22-3.

### Second Embodiment

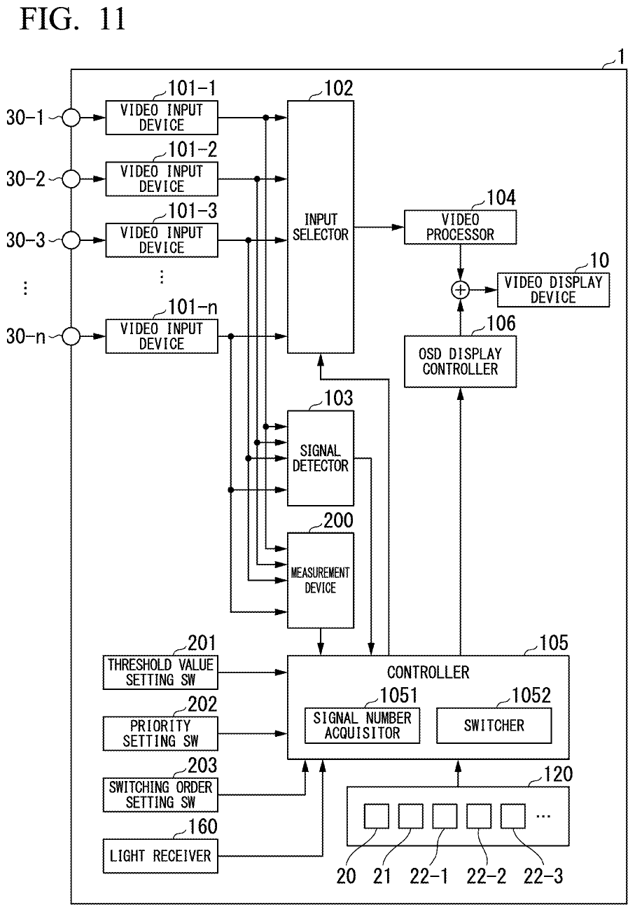

A second embodiment of the present invention will be described below. FIG. 11 is a block diagram schematically illustrating a configuration of a display device according to the second embodiment of the present invention. In FIG. 11, the same constituents as in the first embodiment will be referred to by the same reference signs, and thus description thereof will be omitted.

In the present embodiment, n (where n is an integer) video terminals 30-1 to 30-n are provided. To correspond thereto n video input devices 101-1 to 101-n are provided. The signal detector 103 detects whether there is a video signal from the n video terminals 30-1 to 30-n, and the input selector 102 selects a desired video signal out of n video inputs.

In the present embodiment, a measurement device 200 that measures a use situation of a user is provided. The measurement device 200 measures a time in which each of the video terminals 30-1 to 30-n has been selected to be displayed and calculates a use frequency on the basis of a length of the time. Here, as the time becomes longer, the user frequency becomes higher.

The measurement device 200 measures the number of times each of the video terminals 30-1 to 30-n has been selected as a switching destination and calculates the use frequency on the basis of the number of times. Here, as the number of times becomes larger, the use frequency becomes higher.

The measurement device 200 may count up the number of times the corresponding video terminal has been selected as a switching destination when the time until a next operation input for switching after the switching is equal to or greater than a predetermined time (for example, 10 minutes).

The use situation measured by the measurement device 200 is sent to the controller 105. Then, the switcher 1052 of the controller 105 determines a video input to be preferentially selected with reference to the user situation. For example, in an initial state, a video terminal with a high use frequency is set on the basis of the measurement result from the measurement device 200. In the toggle operation mode, the video input may be switched in the descending order of the user frequencies. In the total display selected operation mode, the video terminals corresponding to the operators 22-1 to 22-3 may be disposed in the descending order of the use frequencies.

In the present embodiment, a threshold value setting switch 201, a priority setting switch 202, and a switching order setting switch 203 are provided.

The threshold value K for the number of video inputs used to determine what of the toggle operation mode and the total display selected operation mode is to be set can be set by the threshold value setting switch 201. For example, when a predetermined value is set as the threshold value K in an initial stage and an operation input on the threshold value setting switch 201 is performed by a user, the controller 105 may change the threshold value K to a value based on the operation input. Accordingly, the user can change the threshold value K to an arbitrary value.

A video terminal to be preferentially set as a video input can be set by the priority setting switch 202. The order in which video inputs are switched whenever the operator is operated in the toggle operation mode can be set by the switching order setting switch 203.

That is, the switcher 1052 receives an operation input for registering the order in which the video signals are switched using the switching order setting switch 203 and switches the video signals in the registered order on the basis of the operation on the operator 20 when the detected number of video signals is equal to or less than the threshold value.

When the detected number of video signals is equal to or less than the threshold value, the switcher 1052 switches the video signal to the video signals of a plurality of video terminals 30-1 to 30-n in the priority order.

When the detected number of video signals is not equal to or less than the threshold value, the switcher 1052 switches the video signal to the video signals of the plurality of video terminals 30-1 to 30-n in the descending order of user frequencies of the video terminals.

The threshold value setting switch 201, the priority setting switch 202, and the switching order setting switch 203 may be operated using the operators provided on the display device 1 or may be operated using a remote controller for inputting an operation input to the display device 1.

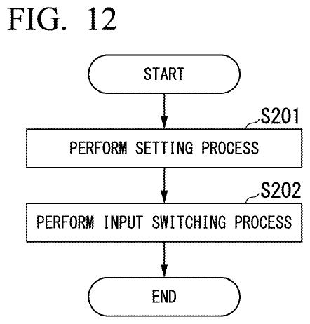

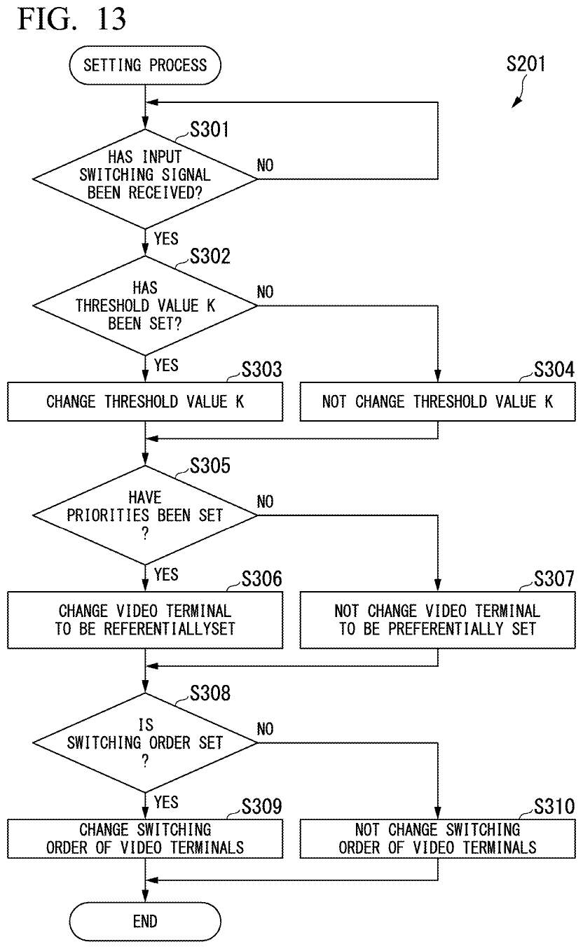

FIGS. 12 and 13 are flowcharts illustrating a process flow according to the second embodiment of the present invention.

As illustrated in FIG. 12, in the present embodiment, a setting process (Step S201) is performed before an input switching process (Step S202). The setting process (Step S201) represents processes of setting various settings using the threshold value setting switch 201, the priority setting switch 202, and the switching order setting switch 203. As described above, the input switching process (Step S202) is a process of switching a video input according to the number of video terminals from which a video input has been performed out of the video terminals 30-1 to 30-n. The process at this time is basically the same as the process flow illustrated in FIG. 10, and thus description thereof will be omitted.

FIG. 13 is a flowchart illustrating the setting process (Step S201 in FIG. 12) according to the second embodiment of the present invention.
(Step S301) The controller 105 determines whether an input switching signal has been received. When an input switching signal has been received (Step S301: YES), the controller 105 causes the process flow to proceed to Step S302.
(Step S302) The controller 105 determines whether the threshold value K has been set through the operation on the threshold value setting switch 201. The controller 105 causes the process flow to proceed to Step S303 when the threshold value K has been set (Step S302: YES) and causes the process flow to proceed to Step S304 when the threshold value K has not been set (Step S302: NO).
(Step S303) The controller 105 changes the threshold value K on the basis of a value set by the threshold value setting switch 201 and causes the process flow to proceed to Step S305.
(Step 304) The controller 105 does not change the threshold value K and causes the process flow to proceed to Step S305.
(Step S305) The controller 105 determines whether priorities have been set through the operation on the priority setting switch 202. The controller 105 causes the process flow to proceed to Step S306 when priorities have been set (Step S305: YES) and causes the process flow to proceed to Step S307 when priorities have not been set (Step S305: NO).
(Step S306) The controller 105 changes the priorities on the basis of the settings set by the priority setting switch 202 and causes the process flow to proceed to Step S308.
(Step S307) The controller 105 does not change the priorities and causes the process flow to proceed to Step S308.
(Step S308) The controller 105 determines whether the switching order has been set through the operation on the switching order setting switch 203. The controller 105 causes the process flow to proceed to Step S309 when the switching order has been set (Step S308: YES) and causes the process flow to proceed to Step S310 when the switching order has not been set (Step S308: NO).
(Step S309) The controller 105 changes the switching order on the basis of the settings set by the switching order setting switch 203 and ends the setting process (Step S201).
(Step S310) The controller 105 does not change the switching order and ends the setting process (Step S201).

### Modified Examples, Application Examples

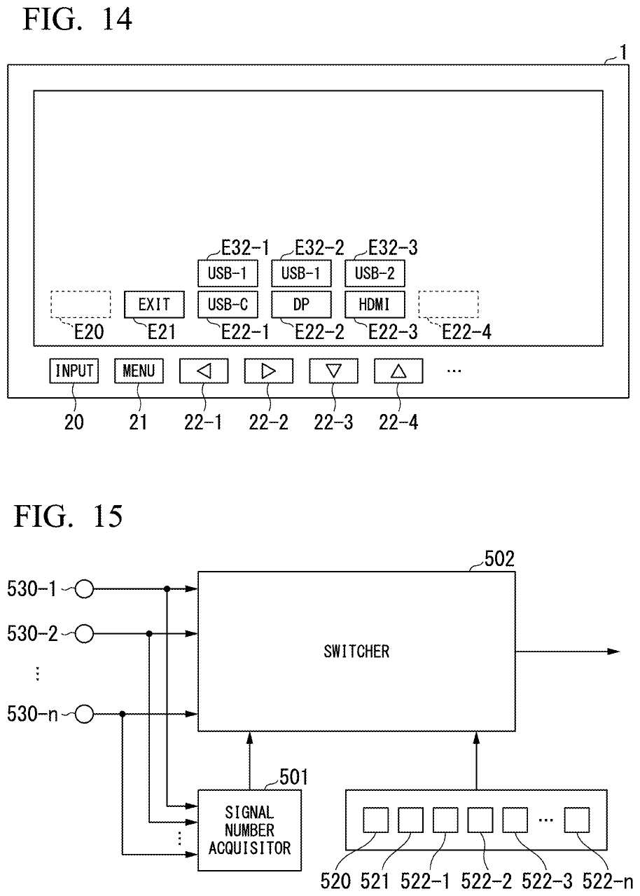

In the aforementioned embodiments, terminal names of the video terminals are displayed in the OSD images E22-1 to E22-4, and USB names may be additionally displayed. FIG. 14 is a diagram illustrating a modified example of the present invention. A USB device can be connected to the display device 1. In FIG. 14, USB device names connected to the display device 1 are displayed in OSD images E32-1 to E32-3. When a USB device is a hard disk and communication is cut off while performing a writing or reading process, the USB device may be damaged. By displaying the USB device names, it is possible to ascertain a switching state of the USB device when the video input terminal has been changed and thus to achieve protection of the USB device.

In the aforementioned embodiments, a plurality of operators 20, 21, and 22-1 to 22-4 disposed in the video display device 10 are operated, but the present invention can also be applied to operators disposed in a remote controller in the same way.

In the aforementioned embodiments, the plurality of operators 20, 21, and 22-1 to 22-4 are provided in the periphery of the front surface of the display device 1, but the operators 20, 21, and 22-1 to 22-4 may be provided on the surface opposite to the surface on which the display screen of the display device 1 is provided. The plurality of operators 20, 21, and 22-1 to 22-4 may be operators which can be physically pressed or may be touch operators that receive an operation input by detecting a change in capacitance.

FIG. 15 is a block diagram illustrating a video signal switching device according to another aspect of the present invention. The video signal switching device according to the present invention includes a signal number acquisitor 501 and a switcher 502. The signal number acquisitor 501 acquires the number of video signals which are input to video terminals 530-1 to 530-n of an electronic device including a plurality of video terminals to which video signals which are externally supplied are able to be input. The switcher 502 switches a video signal to a video signal from the video terminals corresponding to an operator on which an operation input has been performed out of operators 522-1 to 522-n allocated to a plurality of video terminals 530-1 to 530-n to which the video signals are input on the basis of the acquired number of video signals and a threshold value when the acquired number of video signals is greater than the threshold value and switches the video signal on the basis of an operation input to one operator 520 when the acquired number of video signals is equal to or less than the threshold value.

The whole or part of the display device 1 according to the aforementioned embodiments may be realized by a computer. In this case, these functions may be realized by recording a program for realizing the functions on a computer-readable recording medium and causing a computer system to read and execute the program recorded on the recording medium. The “computer system” mentioned herein includes an OS or hardware such as peripherals. The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that dynamically holds a program for a short time such as a communication line when a program is transmitted via a network such as the Internet or a communication circuit line such as a telephone line or a medium that holds a program for a predetermined time such as a volatile memory in a computer system serving as a server or a client in that case. The program may be a program for realizing some of the aforementioned functions, may be a program for realizing the aforementioned functions in combination with another program stored in advance in the computer system, or may be a program for realizing the aforementioned functions using a programmable logic device such as a field-programmable gate array (FPGA).

While embodiments of the present invention have been described above in detail with reference to the drawings, any configurations are not limited to the embodiments and include designs or the like without departing from the gist of the invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

20, 21, 22-1 to 22-n Operator
30-1 to 30-n Video terminal
102 Input selector
103 Signal detector
104 Video processor
105 Controller
106 OSD display controller
1051 Signal number acquisitor
1052 Switcher

What is claimed is:

1. A video signal switching device comprising:
a signal number acquisitor configured to acquire the number of video signals which are to be input to a plurality of video terminals of an electronic device, the plurality of video terminals being configured to receive inputs of video signals from outside the electronic device; and
a switcher configured to perform switching operations, on the basis of the number of video signals acquired and a threshold,
the switcher being configured to switch, based on a first mode operator as operated and included in a plurality of first mode operators configured to receive video signal switching operation, video signals from the plurality of video terminals respectively allocated with the plurality of first mode operators, in case that the number of video signals acquired exceeds the threshold,
the switcher being configured to switch the video signals every time operation of a second mode operator configured to receive video signal switching operation, in case that the number of video signals acquired does not exceed the threshold.

2. The video signal switching device according to claim 1, wherein the switcher is configured not to switch the video signal upon operation of the second mode operator only if the number of video signals acquired is 1, even in case that the number of video signals acquired does not exceed the threshold.

3. The video signal switching device according to claim 1, wherein the switcher being configured to switch in order the video signals which have been detected, every time operation of the second mode operator configured to receive video signal switching operation and different from the plurality of first mode operators, in case that the number of video signals acquired does not exceed the threshold.

4. The video signal switching device according to claim 1, further comprising:
a display controller configured to display an OSD image on a display screen of the electronic device,
wherein the display controller is configured to display, on the OSD image, a notification indicating that into which video signal is to be switched upon a next operation of the second mode operator, in case that the number of video signals acquired does not exceed the threshold.

5. The video signal switching device according to claim 4, wherein the display controller is configured to display, on the OSD image, a name of the video terminal selected in accordance with the operation of the second mode operator and to display, on the OSD image, the notification in a display mode different from that of the name, in case that the number of video signals acquired does not exceed the threshold.

6. The video signal switching device according to claim 4, wherein the display controller is configured to not display, on the OSD image, the notification, in case that the number of video signals acquired exceeds the threshold.

7. The video signal switching device according to claim 1, wherein the switcher is configured to have received switching-order-registration operations for registering in advance a switching order in accordance with which the video signals are to be switched,
wherein the switcher is configured to switch, in the switching order registered in advance, the video signals every time operation of the second mode operator, in case that the number of video signals acquired exceeds the threshold.

8. The video signal switching device according to claim 1, wherein the switcher is configured to switch the video signals in a priority order every time operation of the second mode operator, in case that the number of video signals acquired exceeds the threshold.

9. The video signal switching device according to claim 1, wherein the switcher is configured to switch the video signals in a use frequency order every time operation of the second mode operator, in case that the number of video signals acquired exceeds the threshold.

10. The video signal switching device according to claim 1, wherein the second mode operator is different from the plurality of first mode operators respectively allocated to the plurality of video terminals.

11. The video signal switching device according to claim 1, further comprising:
a controller configured to change a value of the threshold on the basis of an operation input by a user.

12. A video signal switching method comprising:
acquiring the number of video signals which are to be input to a plurality of video terminals of an electronic device, the plurality of video terminals being configured to receive inputs of video signals from outside the electronic device; and
performing switching operations, on the basis of the number of video signals acquired and a threshold,
wherein performing the switching operations comprises:
switching, based on a first mode operator as operated and included in a plurality of first mode operators configured to receive video signal switching operation, video signals from the plurality of video terminals respectively allocated with the plurality of first mode operators, in case that the number of video signals acquired exceeds the threshold; and
switching the video signals every time operation of a second mode operator configured to receive video signal switching operation, in case that the number of video signals acquired does not exceed the threshold.
